(19) United States
(12) Patent Application Publication
(10) Pub. No.: US 2012/0254442 A1
(43) Pub. Date: Oct. 4, 2012

(54) Service Control System Implementing Resource Allocation With Multitasking Communication Terminals

(75) Inventors: Satoshi UEMURA, Fujimino-shi (JP); Hajime Nakamura, Fujimino-shi (JP); Sumaru Niida, Fujimino-shi (JP)

(73) Assignee: KDDI Corporation

(21) Appl. No.: 13/429,687

(22) Filed: Mar. 26, 2012

(30) Foreign Application Priority Data
Mar. 31, 2011 (JP) 2011-079024

(51) Int. Cl. G06F 15/173

(52) U.S. Cl. 709/226

(57) ABSTRACT

A service control device is connected to a plurality of communication terminals with a multitasking ability of executing a plurality of application programs. Each communication terminal detects a usage status including a task status, a foreground ratio, and an operation frequency for each application program, thus producing service usage information reflecting a service usage history and a degree of user's concentration. The service control device determines a priority on communication terminals based on service usage information, thus generating service control information. The service control information is provided to control resource allocation per each communication terminal. A band allocation control procedure is implemented based on service control information so that each communication terminal may arbitrarily download a plurality of content data in a serial manner or in a parallel manner. Thus, it is possible to maintain a high level of user satisfaction in communication services.

### BACKGROUND OF THE INVENTION

1. Field of the Invention

The present invention relates to a service control system that implements resource allocation with multitasking communication terminals and in particular to a service control device or a service control method which allocates hardware/network resources to multitasking communication terminals executing services such as application programs.

The present application claims priority on Japanese Patent Application No. 2011-79024, the entire content of which is incorporated herein by reference.

2. Description of the Related Art

Patent Literature 1 (PLT 1: Japanese Patent Publication No. 2010-287046) discloses a resource allocation method suited to a multitasking system with limited computing resources, which is designed to allocate resources to user terminals based on the degree of a user's dissatisfaction and the history of resource usage per each task.

The resource allocation method disclosed in PLT 1 controls computing resources allocated to a CPU and a memory installed in a user terminal, wherein it is not necessary to control resource allocation in collaboration with other user terminals or external systems. It is necessary for a communication system to implement resource allocation not only based on resource usage for each user terminal but also based on conditions of other user terminals and servers, i.e. the overall condition of the communication system.

### SUMMARY OF THE INVENTION

It is an object of the present invention to provide a service control system that is able to maintain a high degree of user's satisfaction with respect to multitasking communication services.

A first aspect of the present invention refers to a service control device connectible to a plurality of communication terminals, each of which is able to execute a plurality of application programs corresponding to a plurality of services in a multitasking environment. The service control device includes a service usage information receiver that receives service usage information representing a service usage history and the degree of a user's concentration on each application program from communication terminals; a service control information generator that determines a priority of controlling services with communication terminals based on service usage information, thus generating service control information based on the priority for each communication terminal; and a service control information provider that provides service control information to a counterpart communication terminal.

The service control device may further include a preference information storage that stores preference information with regard to each of the users who operate communication terminals. Herein, the service usage history includes attribute information regarding services, so that the service control information generator determines a priority, suited to user's preference, based on attribute information and preference information.

In the above, the degree of a user's concentration on each application program is based on foreground execution of each application program on a screen. Alternatively, the degree of a user's concentration on each application program is based on a time ratio pertaining to foreground execution of each application program on screen. Alternatively, the degree of a user's concentration on each application program is based on an operation frequency pertaining to foreground execution of each application program on screen.

A second aspect of the present invention refers to a service control program applicable to a plurality of communication terminals, each of which has a multitasking ability of concurrently executing a plurality of application programs. The service control program causes a computer to implement the steps of: receiving service usage information representing the service usage history and the degree of a user's concentration on each application program from communication terminals; determining the priority of controlling services with communication terminals based on service usage information, thus generating service control information based on the priority with respect to each of the communication terminals; and providing service control information to a counterpart communication terminal.

A third aspect of the present invention refers to a communication terminal having a multitasking ability of concurrently executing a plurality of application programs and which is connectible to a service control device via a network. The communication terminal includes a service usage status detector that determines a usage status including a task status, a foreground ratio for each application program, and an operation frequency for each application program; and a service usage storage that stores service usage information based on the usage status, so that the service control device determines the priority of controlling services based on service usage information.

A fourth aspect of the present invention refers to a service control method applicable to a plurality of communication terminals each of which has a multitasking ability of concurrently executing a plurality of application programs. The service control method includes the steps of: determining a usage status including a task status, a foreground ratio for each application program, and an operation frequency for each application program with respect to each of the communication terminals, thus producing service usage information based on the usage status; determining the priority of controlling services with communication terminals based on service usage information, thus generating service control information based on the priority with respect to each of the communication terminals; and controlling resource allocation based on service control information with a counterpart communication terminal in accordance with a band allocation control procedure which is determined in advance.

According to the present invention, it is possible to maintain a high level of user satisfaction for each user holding a communication terminal with a multitasking ability, irrespective of degradation of networking functionality or traffic congestion in networks.

### BRIEF DESCRIPTION OF THE DRAWINGS

These and other objects, aspects, and embodiments of the present invention will be described in more detail with reference to the following drawings.

FIG. 1 is a block diagram of a communication system implementing a service control system including a service control device that is able to communicate with a communication terminal according to a preferred embodiment of the present invention.

FIG. 2 shows a data configuration of service usage information acquired by the communication terminal.

FIG. 3 shows a detailed data configuration of the category “service type” in service usage information.

FIG. 4A shows screen image in which three windows are displayed on a screen of the communication terminal in a multitasking environment.

FIG. 4B shows another screen image in which three windows are displayed on a screen of the communication terminal in a multitasking environment.

FIG. 5 is a block diagram of the communication terminal

FIG. 6 is a block diagram of the service control device.

FIG. 7 is a flowchart of a service usage information transmitting process executed by the communication terminal.

FIG. 8 is a flowchart of a service usage status detecting process executed by the communication terminal.

FIG. 9 is a flowchart of a service control information generating process executed by the service control device.

FIG. 10A shows a first band allocation control procedure having the communication terminal download three content data in parallel with one-third of its band allocation without determining a priority.

FIG. 10B shows a second band allocation control procedure having the communication terminal serially download three content data with its whole band allocation in the order of descending priorities.

FIG. 10C shows a third band allocation control procedure having the communication terminal serially download three content data with its whole band allocation in the order of descending priorities or in the order of increasing amounts of data.

FIG. 10D shows a fourth band allocation control procedure having the communication terminal download first content data with its whole band allocation and then serially download second and third content data with one-third of its band allocation in the order of descending priorities or in the order of increasing amounts of data.

FIG. 10E shows a fifth band allocation control procedure having the communication terminal firstly download content data with a very high priority and then download other content data in the order of descending priorities or in the order of increasing amounts of data.

### DESCRIPTION OF THE PREFERRED EMBODIMENT

The present invention will be described in further detail by way of examples with reference to the accompanying drawings.

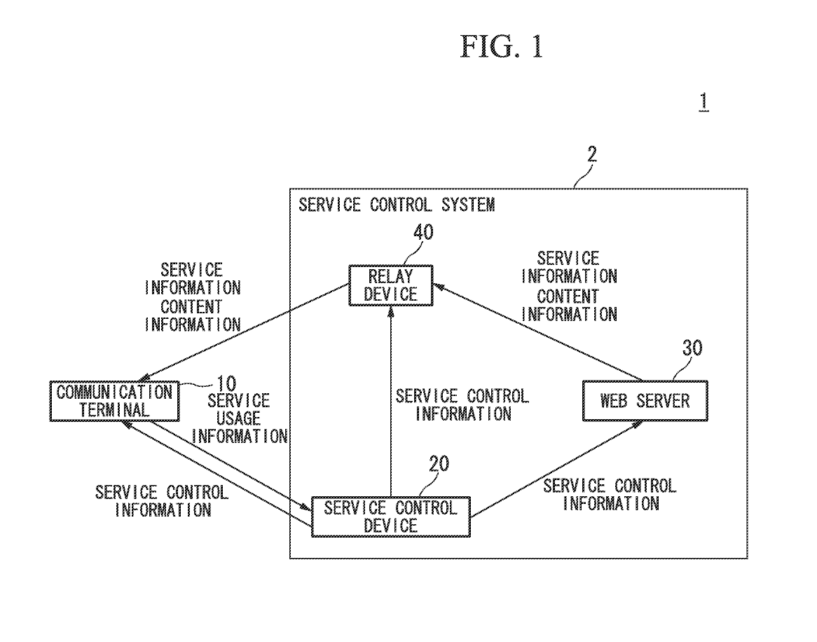

FIG. 1 is a block diagram of a communication system 1 including a service control system 2 and a communication terminal 10. The service control system 2 includes a service control device 20, a Web server 30, and a relay device 40. The communication device 10, the service control device 20, the Web server 30, and the relay device 40 mutually communicate with each other via a network (not shown). This network employs a computer network, a digital telephone network, or telecommunication lines.

In actuality, the communication system 1 may include a plurality of communication terminals 10, whereas for the sake of simplification of description, FIG. 1 shows a single communication device 10. Additionally, the service control system 2 may include a plurality of Web servers 30 and a plurality of relay devices 40, whereas FIG. 1 shows a single Web server 30 and a single relay device 40.

The communication terminal 10 is an information processing terminal with a multitasking ability. Herein, the term “multitasking” implies functionality of switching and executing a plurality of tasks (i.e. units of computer processing) with a CPU. The communication device 10 has a multitasking ability for concurrently executing a plurality of application programs corresponding to various services such as the downloading of content data, the browsing of Web sites, the creation and transmission/reception of emails, as well as voice communication, and the execution of online games. As the communication device 10, it is possible to employ a mobile phone, a mobile information terminal (or a personal digital assistant: PDA), a multifunction mobile phone (namely, a smart phone), and a personal computer.

Upon executing a plurality of application programs in a multitasking manner, the communication device 10 generates service usage information per each service, thus providing service usage information to the service control device 20 at the predetermined timing. The service usage information is provided in the form of a table describing quantitative values or qualitative values of service usage. Additionally, the service usage information represents a service usage history. The predetermined timing is periodical timing with a time interval ranging from three to five seconds. The detailed data configuration of service usage information will be described later.

Upon receiving service control information from the service control device 20, the communication terminal 10 allocates hardware resources and network resources for each of application programs corresponding to services based on service control information. For instance, hardware resources are CPU times and memories on communication terminals, whilst network resources are bandwidths for data transmission and priorities of data transmission.

The communication terminal 10 receives service information and/or content information from the relay device 40, thus allowing a user to use service information and/or content information. The service information may include Web data in Web browsing services, audio data in voice communication services, and emails in email services. The content information may include content data for use in downloading services.

Every time the service control device 20 receives service usage information from each communication device 10, the service control device 20 loads and stores service usage information in a database. The service control device 20 analyzes service usage information stored in the database so as to generate service control information per each communication terminal 10, thus providing service control information to the communication terminal 10, the Web server 30, and the relay device 40. The service control device 20 is a computer or a server.

Upon receiving a request from the communication terminal 10, the Web server 30 provides the communication terminal 10 (i.e. an entity making a request) with service information and/or content information, i.e. objects such as HTML (Hyper Text Markup Language) data and image data.

The Web server 30 receives service control information from the service control device 20 so as to allocate network resources to each communication device based on service control information.

The relay device 40 relays communication between the communication terminal 10 and the Web server 30. The relay device 40 is a router, a proxy server, a networking device such as an access point of a wireless LAN (Local Area Network), or a radio base station.

Upon receiving service control information from the service control device 20, the relay device 40 performs resource allocation in a network environment based on service control information. When service control information indicates degradation in quality of services provided to the communication terminal 10, for example, the relay device 40 may lower a priority in transmitting packets and data to the communication device 10 or minimize window sizes on screen.

Upon receiving service information and/or content information from the Web server 30, the relay device 40 provides the communication terminal 10 (i.e. an entity making a request) with service information and/or content information under control of service control information.

Next, service usage information acquired by the communication device 10 will be described in details.

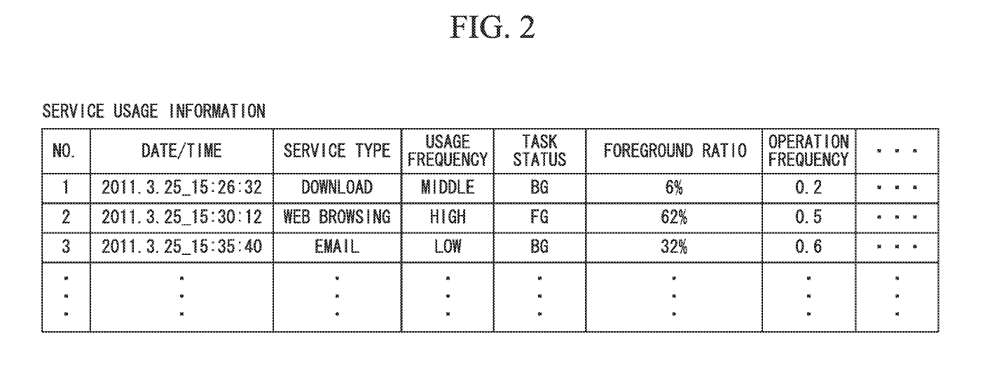

FIG. 2 shows a data configuration of service usage information. The service usage information is provided in the form of a table describing data in connection with various columns such as “number”, “date/time”, “service type”, “usage frequency”, “task status”, “foreground ratio”, and “operation frequency” (all of which are described in columns of a table). Herein, records (i.e. rows of a table) of service usage information are determined for each service, i.e. for each application program executed by the communication terminal 10.

The column “number” is filled with IDs each identifying an application program to be executed by the communication terminal 10. Herein, IDs include characters, numbers, symbols, or their combinations.

When service usage information includes a plurality of tables, or when service usage information is correlated to other tables, the category “number” may serve as a primary key in accessing desired records.

The column “data/time” is filled with temporal information representing a time of creating records or a time of updating records. Herein, temporal information can be expressed as “year/month/data” and “hour/minute/second”.

The column “service type” is filled with service types. Herein, service types can be expressed as “download”, “Web browsing”, “email”, “voice communication”, “game”, or the like.

The column “usage frequency” is filled with usage frequencies each representing a frequency with which a user of the communication terminal 10 used a certain service in a predetermined time in the past. In other words, usage frequencies can be defined as qualitative information representing a ratio of the time, which the communication terminal 10 takes to execute an application program (corresponding to a certain service), to the predetermined time in the past. Herein, a user may arbitrarily change the predetermined time in the past, which may be set to twenty-four hours, one month, one week, or the like. The usage frequencies as qualitative information can be expressed as “extra-high”, “high”, “middle”, “low”, or the like. Using a symbol “U” representing the ratio of the time, which the communication terminal 10 takes to execute an application program, to the predetermined time in the past, the usage frequency is set to “low” when U is less than 25%, “middle” when U is above or equal to 25% but less than 50%, “high” when U is above or equal to 50% but less than 75%, or “extra-high” when U is above or equal to 75%.

In this connection, the column “usage frequency” may be filled with other qualitative information representing the number of times an application program has been executed in the predetermined time in the past. The category “usage frequency” is not necessarily filled with qualitative information; hence, it may be filled with an immediate value such as a temporal ratio or the number of times an application program has been executed.

The column “task status” is filled with task statuses each representing a condition as to whether the communication terminal 10 executes an application program corresponding to a certain service in the foreground or the background. The term “foreground” indicates a condition in which an application program is executed depending on user's operation, whilst the term “background” indicates a condition in which an application program is executed without user's operation. Specifically, the column “task status” is filled with “FG” representing foreground execution or “BG” representing background execution.

The column “foreground ratio” is filled with foreground ratios each representing the ratio of a foreground execution time, in which an application program is subjected to foreground execution, to an execution time of an application program corresponding to a certain service. Herein, the term “execution time” is a time counting from a start time to a current time with respect to an application program.

The column “operation frequency” is filled with operation frequencies each representing a frequency of user's operation conducted during execution of an application program corresponding to a certain service. For instance, the total time is calculated using a time of performing key operation and a time of performing pointer operation with regard to an application program corresponding to a certain service. The ratio of the total time to the execution time of an application program is normalized into a certain value ranging from “0” to “1”. Thus, the category “operation frequency” is filled with normalized values each representing a ratio of a total time (i.e. sum of key operation and pointer operation) to an execution time of an application program.

Among constituent elements of service usage information, a task status, a foreground ratio, and an operation ratio represent a user's concentration ratio on an application program.

In this connection, service usage information may include communication-related elements such as a size of content data and a transmission rate.

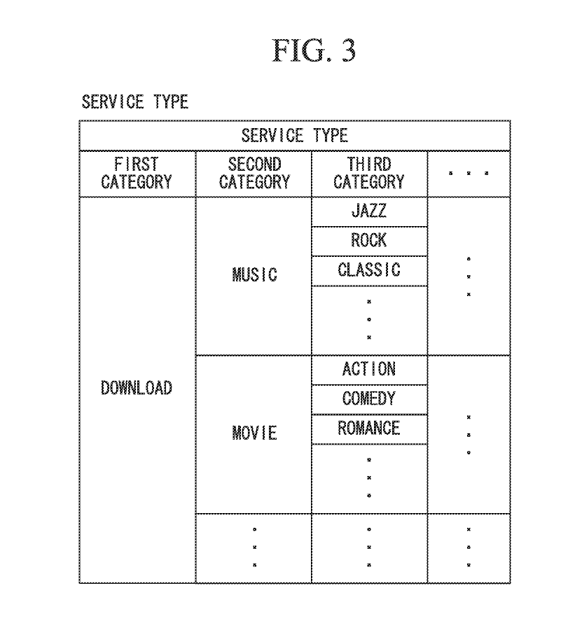

FIG. 3 shows a detailed data configuration regarding the category “service type” in service usage information. Specifically, a service type corresponding to a download service is subdivided into various categories, namely a first category, a second category, a third category, . . . . The term “download” is assigned to the first category while content types are described in the second category. For instance, it is possible to describe the term “music” representing music content, the term “movie” representing movie content, and the term “book” representing book content in the second category. Additionally, genres are assigned to the third category. For instance, it is possible to describe music genres such as “jazz”, “rock”, and “classic”, movie genres such as “action”, “comedy”, and “romance”, and book genres such as “novel”, “academic”, and “dictionary” in the third category. Moreover, it is possible to describe other content-related elements such as dates of content production, production countries, and producers in the fourth category or its following categories.

When the communication terminal 10 downloads action movie content, for example, service usage information includes various elements of service types, in which the first category describes “download”, the second category describes “movie”, and the third category describes “action”. These elements of service types are defined as content attribute information.

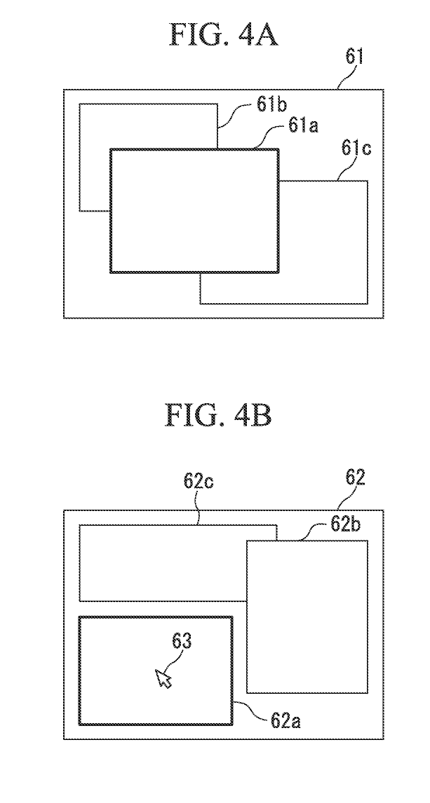

FIGS. 4A and 4B diagrammatically examples of images which are displayed on screen when the communication terminal 10 executes three application programs in a multitasking environment. FIG. 4A shows that windows 61a, 61b, and 61c corresponding to first, second, and third application programs are displayed on a screen 61 installed in the communication terminal 10. In FIG. 4A, the window 61a is displayed on the forefront of the screen 61 so that the window 61a is not partially hidden by the other windows 61b and 61c. The communication terminal 10 detects the window 61a, which is displayed in the forefront of the screen 61, so as to select the first application program (corresponding to the window 61a) as a foreground-executed program.

FIG. 4B shows that windows 62a, 62b, and 62c corresponding to first, second, and third application programs are displayed on a screen 62 installed in the communication terminal 10. In FIG. 4B, the window 62a does not overlap with other windows 62b and 62c, but the window 62a is currently selected by the communication terminal 10. Specifically, a user of the communication terminal 10 currently operates the window 62a with a pointer 63. The communication terminal 10 detects a selected window, e.g. the window 62a currently operated with the pointer 63, so as to select the first application program (corresponding to the window 62a) as a foreground-executed program.

In this connection, the communication terminal 10 may select the first program corresponding to the window 62a, which is currently operated using a key instead of the pointer 63, as a foreground-executed program.

Next, a functional configuration of the communication terminal 10 will be described.

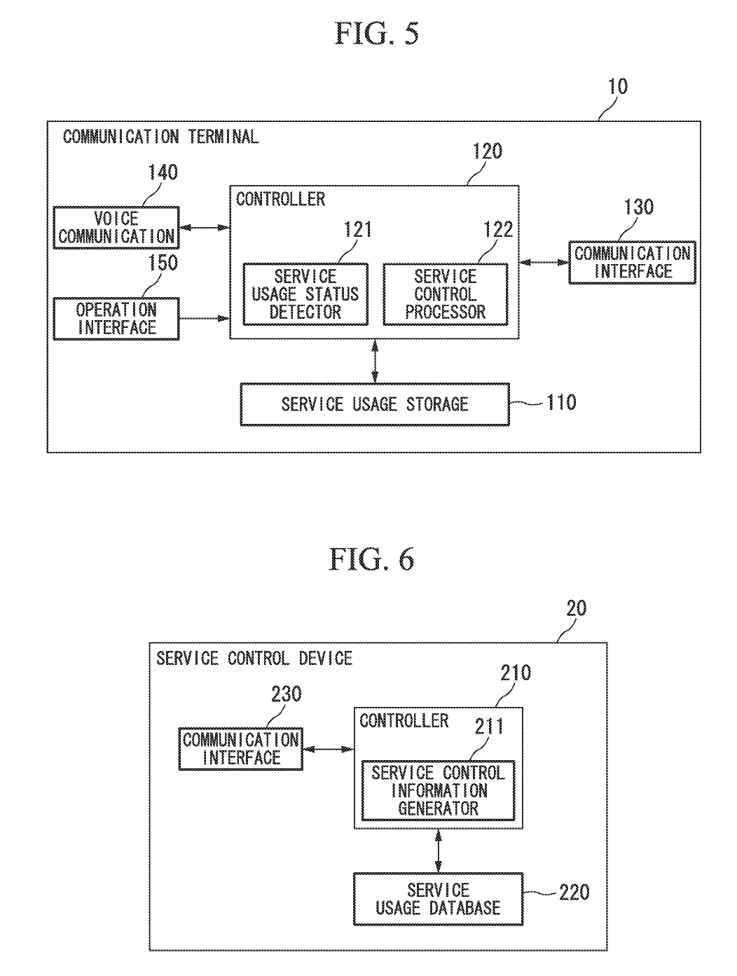

FIG. 5 is a block diagram showing the functional configuration of the communication terminal 10. The communication terminal 10 includes a service usage storage 110, a controller 120, a communication interface 130, a voice communication part 140, and an operation interface 150.

The service usage storage 110 stores service usage information shown in FIGS. 2 and 3. The service usage storage 110 is a semiconductor device such as a read/write memory.

The controller 120 is a CPU coupled with a memory (not shown). The CPU loads and executes a control program stored in the memory, thus controlling the communication terminal 10. Additionally, the CPU loads and executes one or a plurality of application programs stored in the memory. The CPU may execute a plurality of application programs in a multitasking environment. For instance, the CPU may execute various types of application programs such as a download application of content data, a Web browser, an email client, a voice communication application, and a game application.

The controller 120 includes functional blocks, namely a service usage status detector 121 and a service control processor 122.

The service usage status detector 121 monitors and detects usage status per each service, i.e. per each application program executed by the CPU. Upon detecting a change of usage status, the service usage status detector 121 updates service usage information stored in the service usage storage 110 with the changed usage status. The service control processor 122 receives service control information from the service control device 20 via the communication interface 130. Based on the received service control information, the service control processor 122 perform resource allocation in a hardware environment and resource allocation in a network environment in order to execute an application program corresponding to a certain service.

The communication interface 130 is used to establish communication between the service control device 20 and the relay device 40. The controller 120 forwards service usage information to the communication interface 130, which in turn provides service usage information to the service control device 20. Additionally, the service control device 20 forwards service control information to the communication interface 130, which in turn provides service control information to the controller 120. Moreover, the relay device 40 forwards service information and content information to the communication interface 130, which in turn provides service information and content information to the controller 120.

The voice communication part 140 implements a telephone function when the controller 120 executes a voice communication application.

The operation interface 150 includes keys, a touch panel, and a pointing device for receiving manual operation. Upon detecting user's operation, the operation interface 150 generates an operation signal so as to supply it to the controller 120.

Next, a functional configuration of the service control device 20 will be described.

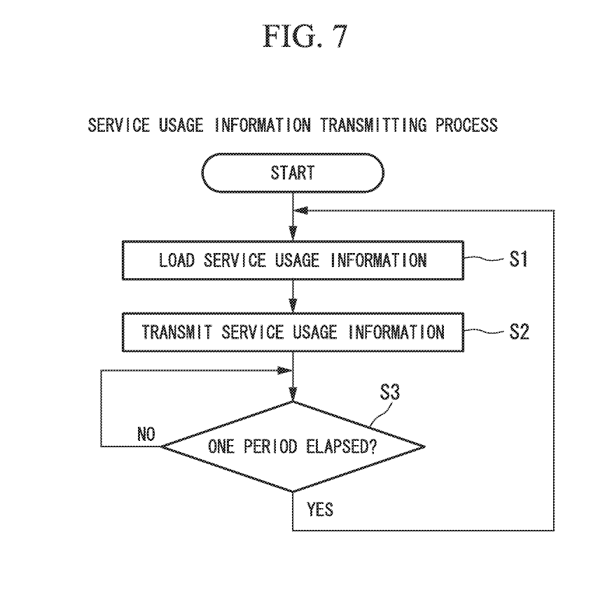

FIG. 6 is a block diagram showing the functional configuration of the service control device 20. The service control device 20 includes a controller 210, a service usage database 220, and a communication interface 230 (serving as a service usage information receiver and a service control information provider).

The controller 210 is a CPU coupled with a memory (not shown). The CPU loads and executes a service control program stored in the memory, thus controlling the service control device 20. Upon receiving service usage information from the communication terminal 10 via the communication interface 230, the controller 210 provides service usage information to the service usage database 220.

The controller 210 includes a service control information generator 211, which analyzes service usage information stored in the service usage database 220, thus generating service control information for each communication terminal 10.

The service usage database 220 receives service usage information from the controller 210 so as to store service usage information together with information (e.g. a terminal number and an address) specifying the communication terminal 10 (i.e. an entity for providing service usage information). The service usage database 220 is a magnetic hard-disk unit.

The communication interface 230 establishes communication between the communication terminal 10 and the relay device 40. The communication interface 230 receives service control information from a plurality of communication terminals 10 so as to forward service control information to the controller 210. Additionally, the communication interface 230 receives service control information from the controller 210 so as to supply service control information to the counterpart communication terminal 10 as well as the Web server 30 and the relay device 40.

Next, the operation of the communication system 1 will be described with respect to a service usage information transmitting process executed by the communication terminal 10, a service usage status detecting process executed by the control terminal 10, and a service control information generating process executed by the service control device 20.

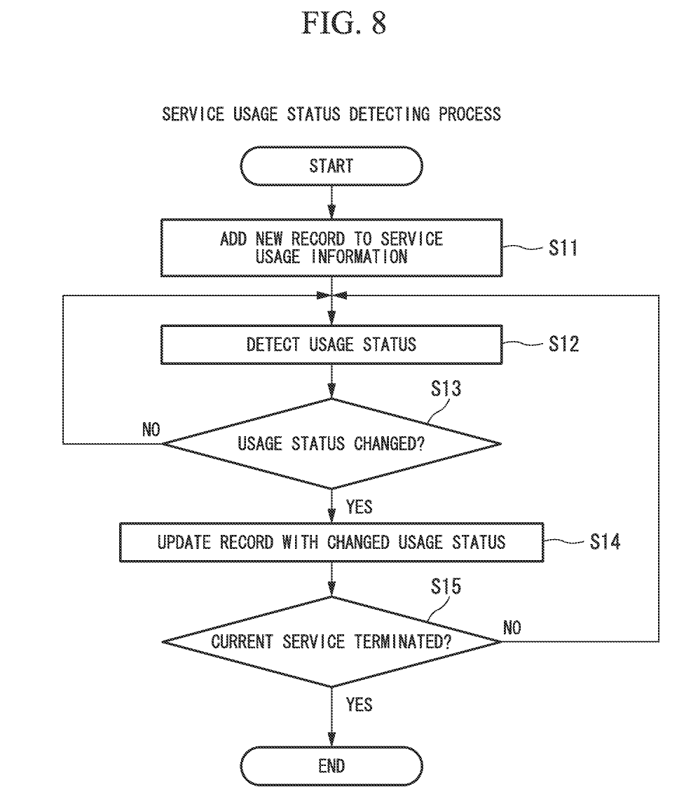

FIG. 7 is a flowchart of the service usage information transmitting process executed by the communication terminal 10. The controller 120 of the communication terminal 10 executes a control program to carry out the service usage information transmitting process.

In step S1, the controller 120 loads service usage information from the service usage storage 110.

In step S2, the controller 120 forwards service usage information to the communication interface 130.

Upon receiving service usage information from the controller 120, the communication interface 130 packetizes service usage information into packets and data so as to transmit them to the service control device 20.

In step S3, the controller 120 is placed in a standby state until a predetermined time elapses (i.e. “NO” in step S3). When the predetermined time elapsed (i.e. “YES” in step S3), the controller 120 reverts its operation to step 51. The predetermined time is a period ranging from three to five seconds.

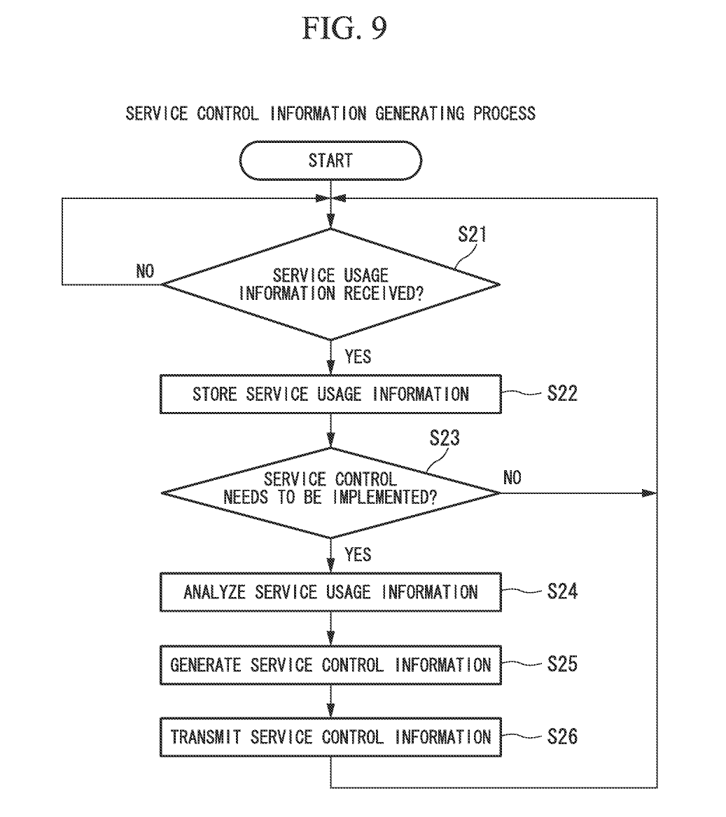

FIG. 8 is a flowchart of the service usage status detecting process executed by the communication terminal 10. The controller 120 of the communication terminal 10 executes a control program to carry out the service usage status detecting process. Herein, the flowchart of FIG. 8 indicates a processing procedure which is executed for each application program.

The processing procedure of FIG. 8 is started when the controller 120 starts to execute one application program. In step S11, when no service usage information is stored in the service usage storage 110, the controller 120 newly creates records for use in service usage information. When the service usage storage 110 has stored service usage information, the controller 120 adds records to service usage information. For instance, the controller 120 newly creates or adds records with regard to service usage information shown in FIGS. 2 and 3.

The controller 120 newly creates or adds various records with regard to service usage information having a table form shown in FIG. 2. Specifically, the controller 120 assigns an identifier, identifying an application program to be executed, to the column “number”; the controller 120 assigns a current date/time to the column “date/time”; and the controller 120 assigns a service type representing an application program to be executed to the column “service type”. The controller 120 converts the ratio of an execution time of an application program (corresponding to a certain service) to a predetermined time in the past into qualitative information, i.e. a usage frequency. Thus, the controller 120 assigns a usage frequency to the column “usage frequency”. Additionally, the controller 120 assigns Null (or no operation) to the column “task status”, the column “foreground ratio”, and the column “operation frequency”.

In step S12, the service usage status detector 121 of the controller 120 monitors and detects a usage status of the communication terminal 10. The usage status is a decision value depending on a task status of an application program, a foreground ratio of an application program, and an operation frequency of an application program.

Specifically, the service usage status detector 121 detects a task status as to whether an application program is subjected to foreground execution or background execution, thus determining a decision value depending on the detection result. There are two examples of procedures in determining decision values. A first example of procedure refers to FIG. 4A in which the service usage status detector 121 checks whether or not an application program corresponds to a forefront window displayed on screen, thus determining whether an application program is executed in the foreground or the background. A second example of procedure refers to FIG. 4B in which the service usage status detector 121 checks whether a window corresponding to an application program is operated using a key or a pointer, thus determining whether an application program is executed in the foreground or the background.

Upon determining foreground execution, the service usage status detector 121 sets “1” to its decision value. Upon detecting background execution, the service usage status detector 121 sets “0” to its decision value.

The service usage status detector 121 calculates a ratio of a time in which an application program is executed in the foreground to an execution time of an application program, thus producing a foreground ratio.

The service usage status detector 121 calculates a ratio of a total time, including a key operation time and a pointer operation time during execution of an application program, to an execution time of an application program. Subsequently, the service usage status detector 121 normalizes the ratio of the total time to the execution time of an application program into a value ranging from “0” to “1”, thus producing an operation frequency.

With regard to a download service, the service usage status detector 121 detects attributes to downloaded content data, such as content type and genre.

In step S13, the service usage status detector 121 determines whether or not a usage status, which is currently detected in step S12, has been changed from a previous usage status which was detected in a previous cycle. When the service usage status detector 121 determines that the usage status currently detected in step S12 has been changed from a previous usage status or when the currently detected usage status matches with an initial usage status, the controller 120 proceeds to step S14. When the service usage status detector 121 determines that the currently detected usage status is not changed from a previous usage status, the controller 120 reverts to step S12.

In step S14, the service usage status detector 121 updates service usage information with the currently detected usage status which has been changed from a previous usage status or the currently detected usage status which matches with an initial usage status.

In step S15, the controller 120 determines whether or not an application program (corresponding to a certain service) is terminated. Upon detecting termination of an application program, the controller 120 exits the service usage status detecting process of FIG. 8. When an application program is not terminated, the controller 120 reverts to step S12.

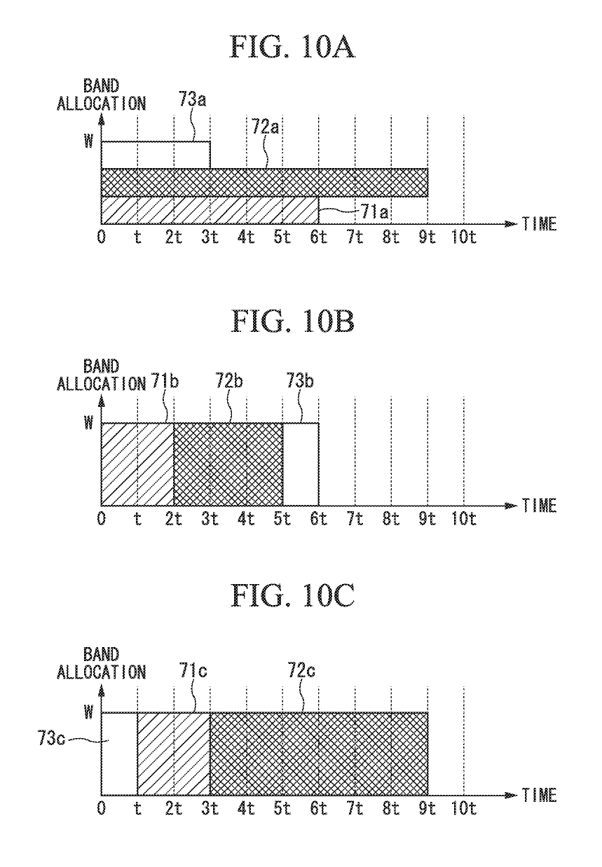

FIG. 9 is a flowchart of the service control information generating process executed by the service control device 20.

In step S21, the communication interface 230 is placed in a state to receive packets and data so that a decision result of step S21 is “NO”. When the communication interface 230 actually receives packets and data from any one of a plurality of communication terminals 10 so that a decision result of step S21 turns to “YES”, the controller 210 proceeds to step S22.

In step S22, the communication interface 230 retrieves service usage information from packets and data received thereby, thus providing service usage information to the controller 210.

The controller 210 loads service usage information from the communication interface 230 so as to provide service usage information to the service usage database 220.

Upon receiving service usage information from the controller 210, the service usage database 220 stores service usage information together with information (e.g. a terminal number and an address) specifying the communication terminal 10.

In step S23, the service control information generator 211 of the controller 210 determines whether or not to conduct service control based on service usage information, relating to a plurality of communication terminals 10, stored in the service usage database 220.

A concrete example regarding a determination step S23 will be described with respect to the situation in which a plurality of communication terminals 10 concurrently accesses the Web server 30 to download content data. This situation may cause a reduction of a network throughput and/or congestion of network communication in the communication system 1, whereby the Web server 30 may be merely able to provide low-quality services to all the communication terminals 10 requesting content data. Based on service usage information stored in the service usage database 220 with regard to a plurality of communication terminals 10, the service control information generator 211 determines that service control will be conducted only when the number of communication terminals 10 concurrently accessing the Web server 30 exceeds a predetermined number.

In step S24, the service control information generator 211 analyzes service usage information stored in the service usage database 220 with regard to a plurality of communication terminals 10. For instance, the service control information generator 211 determines a priority of controlling services per each communication terminal 10 with reference to service usage information which are collected from a plurality of communication terminals 10 and stored in the service usage database 220.

Specifically, the service control information generator 211 determines a priority to provide relatively high-quality services to the communication terminal 10, which is currently executing a content downloading process in the foreground, and the communication terminal 10 whose user is currently concentrating on a content downloading process. In contrast, the service control information generator 211 determines a priority to provide relatively low-quality services to the communication terminal 10, which is currently executing a content downloading process in the background, and the communication terminal 10 whose user is not currently concentrating on a content downloading process.

Next, a procedure for determining a priority will be described. With reference to service usage information stored in the service usage database 220, the service control information generator 211 calculates a score S, representing a usage status for each communication terminal 10 requesting a download service (which is currently being under control), according to Equation (1). Equation (1) is expressed as a function “f” using arguments “C”, “U”, “R”, and “H”. Herein, “C” denotes a value depending on a task status, which is set to “10” relating to “FG” or “1” relating to “BG”. Additionally, “U” denotes a value depending on a usage frequency, which is set to “0.8” relating to “extra-high”, “0.6” relating to “high”, “0.4” relating to “middle”, or “0.2” relating to “low”. Furthermore, “R” denotes a foreground ratio whilst “H” denotes an operation frequency.

S=ƒ(C,U,R,H) (1)

The function “f” according to Equation (1) can be defined as a calculation such as addition and multiplication using arguments.

In this connection, the service control information generator 211 may calculate the score S by applying arbitrary weights to the arguments “C”, “U”, “R”, and “H” in the function “f”. Alternatively, it is possible to store preference information, representing user's pleasure and preference for each communication terminal 10 in the service usage database 220 in advance. In this case, the service control information generator 220 may calculates the score S representing a matching degree between preference information and attribute information (e.g. content types, genres for each service type).

The service control information generator 211 may directly use the score S as a priority. Alternatively, the service control information generator 211 may normalize the score so as to calculate a priority.

In step S25, the service control information generator 211 generates service control information based on an analysis result, i.e. a priority. For instance, the service control information generator 211 calculates a band allocation in response to a priority for each communication terminal 10, thus generating service control information including the priority and the allocation band. Specifically, the service control information generator 211 calculates a band allocation W with respect to the communication terminal 10 of user i in accordance with Equation (2), in which “M” denotes an available band, and “Si” denotes a score calculated on the communication terminal 10 of user i.

$$W = M \times \frac{{S}_{i}}{\sum {S}_{i}} \qquad ( 2 )$$

In step S26, the service control information generator 211 provides service control information to the communication interface 230.

Upon receiving service control information from the service control information generator 211, the communication interface 230 packetizes service control information so as to transmit packets and data to the communication terminal 10, the Web server 30, and the relay device 40. Thereafter, the controller 210 reverts to step S21.

Next, a service control execution process of the communication terminal 10 will be described in connection with a content download process.

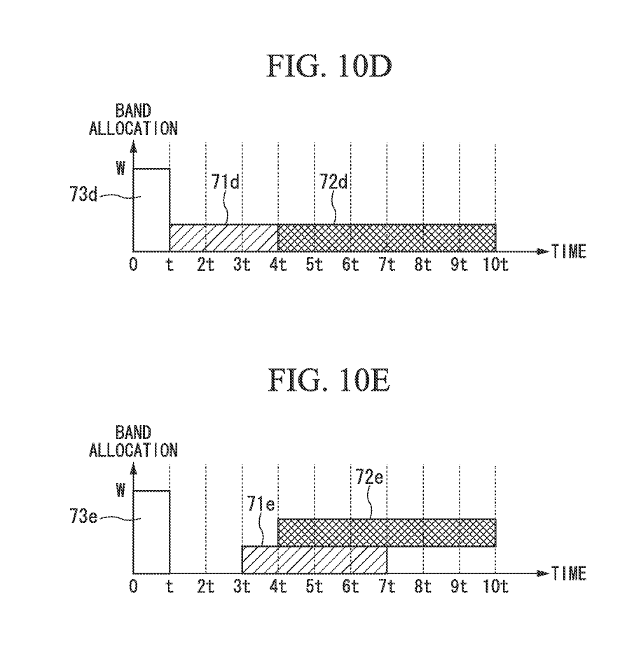

Each of FIGS. 10A to 10E diagrammatically shows a band allocation control over each communication terminal 10 which downloads three content data. FIGS. 10A to 10E are graphs in which the vertical axis represents time whilst the horizontal axis represents band allocation, wherein the symbol “t” on the horizontal axis denotes a unit time (e.g. ten seconds).

FIG. 10A shows a first band allocation control procedure having the communication terminal 10 download three content data 71a, 72a, and 73a in parallel.

In FIG. 10A, the communication terminal 10 concurrently starts downloading content data 71a, 72a, and 73a with an approximately one-third of the allocation band W without determining a priority among them, wherein the downloading of content data 73a is completed at time 3t; the downloading of content data 71a is completed at time 6t; and the downloading of content data 72a is completed at time 9t. The first band allocation control procedure of FIG. 10A is implemented when the communication terminal 10 accesses the Web server with a relatively low access ratio so that a network throughput may not become lower than a predetermined reference value.

FIGS. 10B and 10C show second and third band allocation control procedures, both of which assign the whole allocation band W to the downloading of content data so as to serially download three content data. According to the second band allocation control procedure of FIG. 10B, the communication terminal 10, using the whole allocation band W, downloads content data 71b in a time 2t; then, the communication terminal 10 downloads content data 72b in a time 3t; finally, the communication terminal 10 downloads content data 73b in a time t.

The second band allocation control procedure of FIG. 10B is implemented when the communication terminal 10 accesses the Web server 30 with a relatively low access ratio so that the highest priority is applied to the downloading of content data 71b while the lowest priority is applied to the downloading of content data 73b among three content data 71b, 72b, and 73b.

According to the second band allocation control procedure of FIG. 10B which starts downloading with content data 71b, given the highest priority, among three content data 71b, 72b, and 73b, the communication terminal 10 starts reproducing desired content data with the highest priority (e.g. the highest interest), thus providing a high level of user satisfaction.

According to the third band allocation control procedure of FIG. 10C, the communication terminal 10, using the whole band allocation W, downloads content data 73c in a time t; then, the communication terminal 10 downloads content data 71c in a time 2t; finally, the communication terminal 10 downloads content data 72c in a time 6t.

The third band allocation control procedure of FIG. 10C is implemented when the communication terminal 10 accesses the Web server 30 with a relatively low access ratio so that a download sequence among three content data 71c, 72c, and 73c is determined to apply a higher priority to content data with a smaller amount.

As shown in FIG. 10C, the communication terminal 10 firstly downloads content data 73c, having the smallest amount, which can be retrieved in the shortest time, among three content data 71c, 72c, and 73c. This allows the communication terminal 10 to quickly reproduce content data 73c, thus providing a high level of user satisfaction.

FIG. 10D shows a fourth band allocation control procedure in which the communication terminal 10 assigns the whole band allocation W to the downloading of first content data but assigns one-third of the allocation band W to the downloading of second and third content data, thus serially downloading three content data. According to the fourth band allocation control procedure of FIG. 10D, the communication terminal 10 downloads content data 73d in a time t with the whole band allocation W; then the communication terminal 10 downloads content data 71d in a time 3t with one-third of the band allocation W; finally, the communication terminal 10 downloads content data 72d in a time 6t with one-third of the band allocation W.

The fourth band allocation control procedure of FIG. 10D is implemented when the communication terminal 10 accesses the Web server 30 with a relatively high access ratio so that a download sequence of three content data 71d, 72d, and 73d is determined in the order of descending priorities or in the order of increasing amounts of content data.

As shown in FIG. 10D, the communication terminal 10 is able to quickly download content data 73d with the highest priority among three content data 71d, 72d, and 73d. This allows the communication terminal 10 to quickly reproduce content data 73d, thus providing a high level of user satisfaction. After completion of downloading, the user is likely to quickly start reproducing content data 73d. In this case, the user may give attention to the content being currently reproduced, in other words, it is expected that the user may reduce attention to the downloading of other content data 71d and 72d. For this reason, it is presumed that a small impact may be imparted to user satisfaction even though a narrow band allocation is applied to other content data 71d and 72d. Since one communication terminal 10 narrows its band allocation for use in downloading content data 71d and 72d, the other communication terminal 10 may broaden its band allocation.

A fifth band allocation control procedure of FIG. 10E is implemented when the communication terminal 10 accesses the Web server 30 with a relatively high access ratio so that the priority of downloading content data 73e is significantly higher than priorities of downloading other content data 71e and 72e.

In the communication system 1 adopting the service control device 20, the communication terminal 10 is able to execute a plurality of application programs (corresponding to a plurality of services) in a multitasking environment and designed to produce service usage information, representing a history of service usage for each application program and a degree of user's concentration on each application program, and thus periodically provide service usage information to the service control device 20.

The service control device 20 receives service usage information from a plurality of communication terminals 10 so as to create the service usage database 220 based on service usage information. The service control device 20 determines the priority of controlling services on a plurality of communication terminals 10; subsequently, the service control device 20 produces service control information based on the priority with respect to a plurality of communication terminals 10, thus providing service control information to the counterpart communication terminal 10.

Additionally, the communication terminal 10 receives service control information from the service control device 20 so as to perform resource allocation in a hardware environment and resource allocation in a network environment based on service control information.

Thus, the service control device 20 is able to efficiently perform resource allocation on the entire communication system 1 while maintaining a high level of user's satisfaction (or without degrading user's satisfaction) by use of a plurality of communication terminals 10, each of which is able to execute application programs in a multitasking environment. In other words, the present embodiment adopting a multitasking system is able to maintain a high level of satisfaction with users utilizing communication services.

In this connection, the communication terminal 10 may incorporate the functionality of the service control device 20 so as to autonomously control services.

It is possible to realize a part of the functionality of the service control device 20, e.g. the functionality of the controller 220, by way of a computer. In this case, it is possible to store a service control program (for executing the control functionality) in computer-readable recording media. Herein, a computer system loads the service control program stored in computer-readable recording media, thus achieving the control functionality. Herein, the term “computer system” may encompass software such as an Operating System (OS) and hardware such as peripheral devices. The term “computer-readable recording media” may encompass flexible disks, magneto-optic disks, optical disks, portable recording media such as memory cards, and storage devices such as magnetic hard-disk units installed in computer systems. Additionally, the term “computer-readable recording media” may encompass telecommunication media for dynamically retaining programs in a short period, such as networks (e.g. the Internet) and communication lines (e.g. telephone lines) used for transmitting programs, as well as storage media for retaining programs in a certain time, such as volatile memory installed in computer systems acting as servers and clients. The foregoing programs can be drafted to realize a part of the control functionality. Alternatively, the foregoing programs can be drafted as differential files which are combined with preinstalled programs in computer systems so as to achieve the control functionality.

Lastly, the present invention is not necessarily limited to the foregoing embodiment and its variations, which can be further modified in various ways (e.g. design choices) within the scope of the invention as defined by the appended claims.

What is claimed is:

1. A service control device connectible to a plurality of communication terminals with an ability to execute a plurality of application programs corresponding to a plurality of services in a multitasking environment, said service control device comprising:
a service usage information receiver that receives service usage information representing a service usage history and a degree of user's concentration on each application program from the plurality of communication terminals;
a service control information generator that determines a priority of controlling services with the plurality of communication terminals based on the service usage information, thus generating service control information based on the priority with respect to each of the plurality of communication terminals; and
a service control information provider that provides the service control information to a counterpart communication terminal among the plurality of communication terminals.

2. The service control device according to claim 1, further comprising a preference information storage that stores preference information with regard to each of users who operate the plurality of communication terminals,
wherein the service usage history includes attribute information regarding services, and
wherein the service control information generator determines the priority, suited to user's preference, based on the attribute information and the preference information.

3. The service control device according to claim 1, wherein the degree of user's concentration on each application program is based on foreground execution of each application program on screen.

4. The service control device according to claim 1, wherein the degree of user's concentration on each application program is based on a time ratio pertaining to foreground execution of each application program on screen.

5. The service control device according to claim 1, wherein the degree of user's concentration on each application program is based on an operation frequency pertaining to foreground execution of each application program on screen.

6. A service control program applicable to a plurality of communication terminals with an ability to execute a plurality of application programs corresponding to a plurality of services in a multitasking environment, said service control program causing a computer to implement the steps of:
receiving service usage information representing a service usage history and a degree of user's concentration on each application program from the plurality of communication terminals;
determining a priority of controlling services with the plurality of communication terminals based on the service usage information, thus generating service control information based on the priority with respect to each of the plurality of communication terminals; and
providing the service control information to a counterpart communication terminal among the plurality of communication terminals.

7. A communication terminal, with an ability to execute a plurality of application programs corresponding to a plurality of services in a multitasking environment, connectible to a service control device via a network, said communication terminal comprising:
a service usage status detector that determines a usage status including a task status, a foreground ratio for each application program, and an operation frequency for each application program; and
a service usage storage that stores service usage information based on the usage status, so that the service control device determines a priority of controlling services based on the service usage information.

8. A service control method adapted to a plurality of communication terminals with an ability to execute a plurality of application programs corresponding to a plurality of services in a multitasking environment, said service control method comprising:
determining a usage status including a task status, a foreground ratio for each application program, and an operation frequency for each application program with respect to each of the plurality of communication terminals, thus producing service usage information based on the usage status;
determining a priority of controlling services with the plurality of communication terminals based on the service usage information, thus generating service control information based on the priority with respect to each of the plurality of communication terminals; and
controlling resource allocation based on the service control information with a counterpart communication terminal, among the plurality of communication terminals, in accordance with a band allocation control procedure which is determined in advance.

9. The service control method according to claim 8, wherein the band allocation control procedure allows the counterpart communication terminal to concurrently download a plurality of content data in parallel with a subdivision of its band allocation.

10. The service control method according to claim 8, wherein the band allocation control procedure allows the counterpart communication terminal to serially download a plurality of content data with its band allocation in accordance with the priority.
